(19) United States
(12) Patent Application Publication
(10) Pub. No.: US 2017/0336613 A1
(43) Pub. Date: Nov. 23, 2017

(54) MICROSCOPE HAVING TWO ACCESS OPENINGS FOR THE FLUORESCENCE DEVICE

(71) Applicant: Leica Microsystems CMS GmbH, Wetzlar (DE)

(72) Inventor: Martin Kubek, Driedorf (DE)

(21) Appl. No.: 15/504,660

(22) PCT Filed: Aug. 20, 2015
(86) PCT No.: PCT/EP2015/069137

§ 371 Date: Jun. 13, 2017

(30) Foreign Application Priority Data
Aug. 20, 2014 (DE) 102014111928.2
Nov. 14, 2014 (DE) 102014116648.5

(51) Int. Cl. G02B 21/18; G02B 21/24; G02B 21/06; G02B 21/26; G02B 21/00

(52) U.S. Cl. CPC G02B 21/18; G02B 21/26; G02B 21/0076; G02B 21/06; G02B 21/248

(57) ABSTRACT

A microscope includes a housing having a first opening and at least one second opening. A fluorescence device having exchangeable fluorescence cubes is arranged in a space enclosed by the housing. The fluorescence device is accessible through each of the first opening and the at least one second opening such that a total of at least two openings are provided, via each of which the fluorescence device is accessible and via each of which the fluorescence cubes of the fluorescence device are exchangeable.

### CROSS-REFERENCE TO PRIOR APPLICATIONS

This application is a U.S. National Stage Application under 35 U.S.C. §371 of International Application No. PCT/EP2015/069137 filed on Aug. 20, 2015, and claims benefit to German Patent Application Nos. DE 10 2014 111 928.2 filed on Aug. 20, 2014 and DE 10 2014 116 648.5 filed on Nov. 14, 2014. The International Application was published in German on Feb. 25, 2016 as WO 2016/026926 A1 under PCT Article 21(2).

### FIELD

The invention relates to a microscope that comprises a housing and a fluorescence device, the fluorescence device being arranged in a space enclosed by the housing. The housing comprises a first opening via which the fluorescence device can be accessed.

### BACKGROUND

In fluorescence microscopy, fluorescent dyes are excited by light of one wavelength, the fluorescent dyes then emitting light of another wavelength, known as fluorescence light. The sample has to be excited by light of a different wavelength, depending on the fluorescent dye. Likewise, the wavelength of the emitted fluorescence light differs depending on the dye.

In order to be able to accordingly examine by microscope samples having different fluorescent dyes, fluorescence microscopes comprise florescence devices in which a plurality of fluorescence cubes can be received, one of which cubes can be introduced, as desired, into the beam path of the microscope in each case. The fluorescence cubes in particular comprise an excitation filter that ensures that the light emitted by a light source is filtered such that only the excitation light having the excitation wavelength passes through the excitation filter. The fluorescence cubes further comprise a beam splitter by means of which the excitation light is reflected to the sample. The fluorescence light emitted by the sample passes through the beam splitter and through a barrier filter, through which only fluorescence light having the fluorescence wavelength can pass, and into the tube and/or the camera of the microscope.

Since, by nature, fluorescence devices of this kind only have a limited number of cavities for receiving different fluorescence cubes, it is necessary for the fluorescence cubes to be able to be exchanged easily.

DE 10 2004 034 887 B4 discloses a microscope that comprises a pivoting drawer that can pivot about an axis of rotation and by means of which the rotary table, on which the fluorescence cubes are mounted, can be pivoted out of an opening in the housing of the microscope such that the fluorescence cubes can be exchanged easily.

DE 44 04 286 C2 describes a microscope in which the rotary table comprising the fluorescence cubes is arranged on a drawer that can be moved out of an opening in the housing in order to change the fluorescence cubes.

### SUMMARY

In an embodiment, the present invention provides a microscope having a housing with a first opening and at least one second opening. A fluorescence device having exchangeable fluorescence cubes is arranged in a space enclosed by the housing. The fluorescence device is accessible through each of the first opening and the at least one second opening such that a total of at least two openings are provided, via each of which the fluorescence device is accessible and via each of which the fluorescence cubes of the fluorescence device are exchangeable.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view of a fluorescence microscope;

FIG. 2 is a schematic view of a fluorescence device according to a first embodiment;

FIG. 3 is a plan view of the fluorescence device according to FIG. 2;

FIG. 4 is a highly simplified schematic view of a fluorescence microscope according to a first embodiment, viewed from a first side;

FIG. 5 is a schematic view of the microscope according to FIG. 4 viewed from a second side that is opposite the first side;

FIG. 6 is a schematic view of the microscope according to FIGS. 4 and 5 when the cover is removed;

FIG. 7 is a schematic perspective view of a detail of the microscope according to FIG. 4 to 6 viewed from the first side and when the cover is closed;

FIG. 8 is a schematic perspective view of the detail according to FIG. 7 when the cover is taken off;

FIG. 9 is a schematic perspective view of a further detail of the microscope according to FIG. 4 to 6 viewed from the second side and when the cover is closed;

FIG. 10 is a schematic perspective view of the detail according to FIG. 9 when the cover is taken off;

FIG. 11 is a highly simplified schematic view of a fluorescence microscope according to a second embodiment, viewed from the first side;

FIG. 12 is a schematic view of a fluorescence microscope according to FIG. 11 viewed from the second side;

FIG. 13 is a schematic perspective view of a detail of the microscope according to FIGS. 11 and 12 viewed from the first side;

FIG. 14 is a schematic perspective view of a detail of the microscope according to FIGS. 11 and 12 viewed from the second side;

FIG. 15 is a schematic view of a fluorescence device of the microscope according to FIGS. 11 and 14; and

FIG. 16 is a plan view of the fluorescence device according to FIG. 15.

### DETAILED DESCRIPTION

Common to both known microscopes described above is the fact that said microscopes comprise a single opening out of which the pivoting drawer or the drawer can be moved.

The inventor has found that this is disadvantageous, firstly because it is thus only possible to access the fluorescence device from one side, which can be unergonomic either for right-handed or for left-handed people, depending on the side on which said opening is arranged. A further disadvantage recognized by the inventor is that additional functional units arranged externally are often provided on the sides of the microscope. For example, connections for cameras, microscope manipulators, light sources, sample feeders, climate chambers and the like can be provided. If these external units are arranged on the same side as the opening, each of these units firstly have to be removed again before it is possible to access the fluorescence device via the opening. This is associated with significant effort.

In an embodiment, the present invention provides a microscope in which the fluorescence cubes of the fluorescence device can be changed easily.

According to an embodiment of the invention, at least one second opening is provided in the housing, via which opening it is possible to access the fluorescence device.

As a result, a total of two openings are provided, via each of which it is possible to access the fluorescence device and via each of which the fluorescence cubes of the fluorescence device can thus be exchanged.

In particular, the first and the second opening are arranged on opposing sides of the housing. The openings are arranged, in particular, on the left-hand and on the right-hand side of the microscope from the viewpoint of an operator sitting in front of the microscope in the normal observation position.

This has the advantage that it is possible to access the fluorescence device from both sides, and therefore the operator can access the fluorescence device and in particular can exchange fluorescence cubes through the relevant opening in an ergonomically favorable manner, irrespective of whether said person is left-handed or right-handed.

Furthermore, even when external peripheral components, for example cameras, scanners and the like, are arranged on one side of the microscope, access is possible from the other side without said components having to be removed beforehand.

This permits in particular mechanical and optical interfaces for coupling external units without there being any restriction for this in terms of the size of the units or the functionality or the exchange of fluorescence cubes.

The first and the second openings are preferably designed identically so that the same access to the fluorescence device is possible through both openings.

It is particularly advantageous for a first cover to be provided, by means of which the first opening can be closed at least in part. Furthermore, it is advantageous for a second cover to be provided, by means of which the second opening can be closed at least in part. As a result, the components protected by the housing, in particular the fluorescence device, are correspondingly protected by the covers and it is nonetheless still possible to access the fluorescence device by removing the corresponding cover in each case.

The first cover is in particular designed so as to completely close the first opening. In a corresponding manner, the second cover can also be designed so as to completely close the second opening.

Alternatively, the first cover can also close the first opening only in part and/or the second cover can close the second opening only in part. This partial closure may be necessary in particular if the fluorescence device comprises a manually rotatable rotary table, and therefore the only partial closure makes access to this rotary table possible and the desired fluorescence cube can thus be manually rotated into the beam path.

In particular, the first and the second cover are designed such that they can both be fastened, in each case as desired, to both openings, irrespective of whether said covers close the first and second opening completely or close said openings only in part. As a result, the covers can be exchanged easily. In the case of manually rotatable rotary tables, this makes it possible in particular for one cover to be designed so as to completely close the opening in front of which it is arranged, and for the other cover to be designed so as to close the opening only in part. In this case, the left-hand cover and the right-hand cover are therefore designed differently. The operator can then select the side from which he wishes to rotate the rotary table and can arrange the partially closing cover on this side, with the result that it is possible to access the rotary table comprising the fluorescence cubes. The completely closing cover is then fastened to the other side.

The first and the second covers can in particular be designed identically so that the number of parts is reduced and the covers can be exchanged as desired.

In particular, the first and the second covers are designed such that they can be screwed to the housing. In particular, in the case of differently shaped covers, the holes through which the screws pass are arranged in the same pattern, meaning that differently shaped covers, for example covers for covering the respective openings completely and/or only in part, can also be exchanged as desired.

In a particularly preferred embodiment of the invention, the fluorescence device comprises a rotary table that can be rotated about an axis of rotation and in which a plurality of fluorescence cubes can be received in an exchangeable manner. In this case, the rotary table is mounted in particular such that one of the received fluorescence cubes in each case can be pivoted as desired into the beam path of the microscope.

Each fluorescence cube in particular comprises an excitation filter, a beam splitter oriented obliquely at 45° and a barrier filter through which only the fluorescence light can pass to the tube or to the camera.

The rotary table comprises a plurality of receiving cavities, in particular four or eight receiving cavities, in each of which one fluorescence cube, respectively, can be received. The fluorescence cubes can in particular be fixed in the receiving cavities by means of a dovetail fixture or a snap-in connection so that the fluorescence cubes are prevented from falling out of the receiving cavities when the microscope is transported when the rotary table is rotated.

The openings make it possible to access the rotary table from both sides and therefore the fluorescence cubes can be exchanged from both sides.

In a particularly preferred embodiment, the first and the second openings are designed such that the rotary table can be removed through both the first and the second opening. It is therefore possible to easily remove the rotary table through the two openings when changing the fluorescence cubes, for maintenance and/or to exchange the entire fluorescence device, and it is therefore possible to exchange the fluorescence cubes and access the fluorescence device in a particularly convenient manner.

In a particularly preferred embodiment, the rotary table is dimensioned and is positioned in the receiving space such that it is possible to exchange the fluorescence cubes through both the first and the second opening without it being necessary to remove the rotary table for this purpose. For this purpose, the rotary table is in particular designed to be of such a size as to protrude until just before the opening so that it is not necessary to reach far into the space when exchanging the cubes. Moreover, for this purpose, the first and the second openings are in particular designed to be of such a size that the fluorescence cubes can be easily removed from the receiving cavities and new fluorescence cubes can be inserted even when a rotary table is installed.

In an alternative embodiment, the rotary table can also be arranged on a movable drawer. In this case, this drawer is designed such that it can be moved or pulled out of both the first and the second opening, and therefore correspondingly moving or pulling out said drawer through the two openings makes it easy to access the rotary table.

In a further alternative embodiment of the invention, a pivotable drawer can also be provided, the pivoting drawer in turn being designed such that it can be pivoted out of both the first and the second opening. Thus, in this embodiment too, easy access to the fluorescence device is possible through both openings and thus on both sides of the microscope.

It is further advantageous for a motor to be provided for rotating the rotary table. In this embodiment, the first and the second covers are in particular designed so as to completely close the first and second opening. Access to the fluorescence device is thus prevented during operation, resulting in optimal protection of the fluorescence device.

In an alternative embodiment of the invention, the rotary table can also be designed such that it can be rotated manually. In this case, at least one of the two covers is designed so as to not completely close the opening, so that an operator can manually rotate the rotary table via the region of the first or second opening that remains open.

For this purpose, the edge of the rotary table is in particular grooved so that the operator cannot easily lose his grip on the rotary table and can rotate said table particularly easily and safely.

It is further advantageous for the rotary table to protrude at least from one of the two openings, making rotation particularly easy. Alternatively, the rotary table can also not protrude from the opening but rather end immediately in front of the opening when viewed from inside, so that simple rotation is still possible. The rotary table can in particular be dimensioned so as to protrude from the relevant opening on either side, meaning that operation is possible from both sides. Alternatively, the rotary table can also protrude from just one of the openings, it then in particular being possible to change the position of the rotary table within the space enclosed by the housing so that it is possible to adjust from which of the two openings the rotary table protrudes.

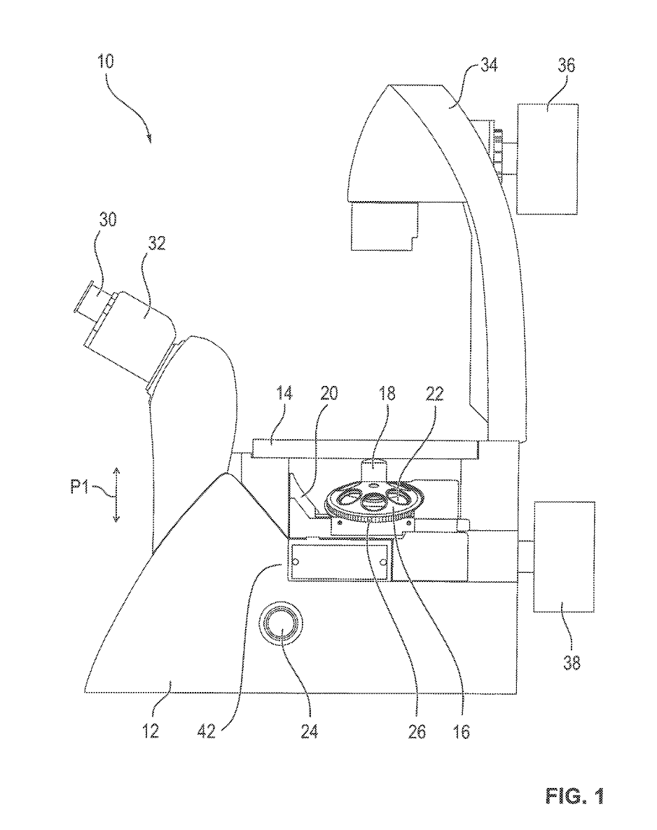

FIG. 1 is a schematic view of a fluorescence microscope 10 viewed from a first side. The microscope 10 comprises a tripod main body 12 to which a microscope stage 14 is rigidly fastened, on which stage the specimen to be viewed, in particular in the form of a microscope slide, can be mounted.

A rotating nosepiece 16 is further provided, which nosepiece comprises a plurality of recesses, one of which is denoted by way of example by reference sign 22. Objectives 18 can be received in each of the recesses 22, just one objective 18 being shown in FIG. 1 for improved clarity of the drawing. In this case, the rotating nosepiece 16 is rotatably fastened to a nosepiece support 20 so that one of the objectives 18 can be rotated into the optical axis of the microscope 10 as desired. In this case, the rotating nosepiece 16 is fastened obliquely to the nosepiece support 20 so that the axis of rotation about which the rotating nosepiece 16 can be rotated extends obliquely to the optical axis.

The rotating nosepiece 16 is in particular rotated manually, for which purpose grooves 26 are provided on the edge thereof, which grooves are intended to prevent the operator from losing his grip. Furthermore, in order to improve operability, the rotating nosepiece 16 projects beyond the nosepiece support in the direction of the first side of the microscope 10 so that the rotating nosepiece 16 can be easily rotated by the operator.

The microscope 10 further comprises an ocular lens 30 and a tube 32 through which the operator can observe the specimen. Furthermore, in order to illuminate the specimen, both a transmitted light source 36, fastened to a transillumination arm 34, and an incident light source 38 are provided.

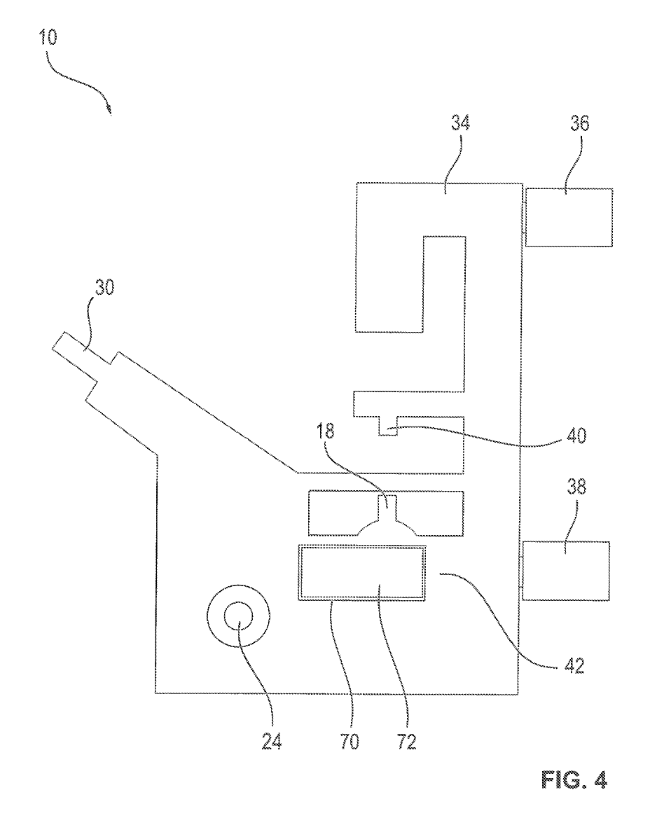

The microscope 10 further comprises a condenser 40 (FIG. 4) that is arranged in the beam path of the transmitted light.

The nosepiece support 20 is fastened to the tripod main body 12 so as to be movable relative to the tripod main body 12, and thus also relative to the microscope stage 14, in the direction of the double-headed arrow P1, this movement direction being oriented in parallel with the optical axis of the microscope 10. The specimen to be observed can be focused by correspondingly adjusting the nosepiece support 20 and thus the rotating nosepiece 16.

In order to adjust the nosepiece support 20, an adjustment knob 24 is provided on the first side of the microscope, by means of which the operator can control the movement of the nosepiece support 20. In this case, the movement can occur either purely mechanically or in a motorized manner, as desired.

The microscope 10 further comprises a fluorescence device which is not visible in FIG. 1 since it is arranged in a space below the rotating nosepiece 16 that is enclosed by the housing 42 of the microscope 10.

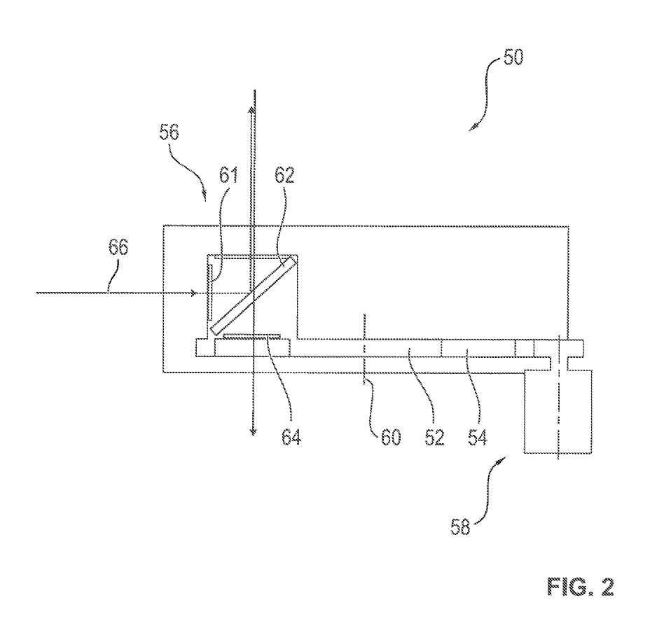

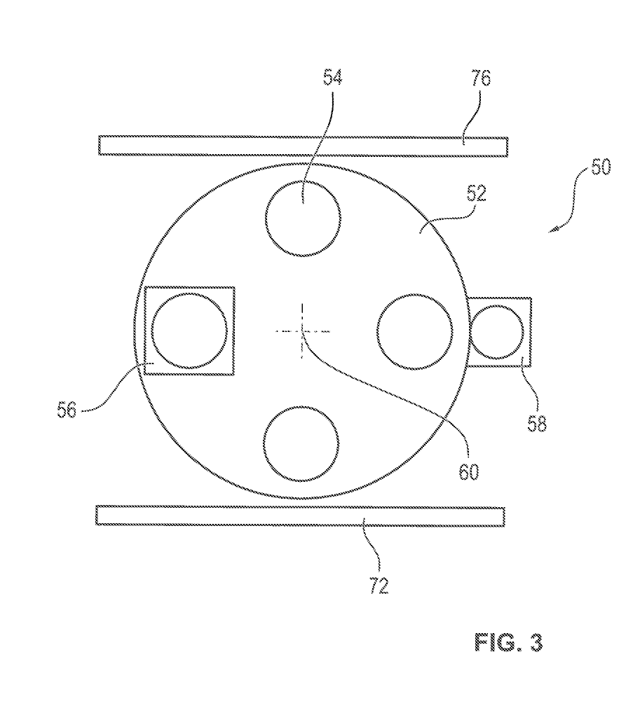

FIG. 2 is a schematic side view of a fluorescence device 50 of this kind for a microscope 10 according to a first embodiment. FIG. 3 is a plan view of the fluorescence device 50.

The fluorescence device 50 comprises a rotary table 52 that comprises four openings, one of which is denoted by way of example by reference sign 54. One fluorescence cube 56, respectively, can be fastened in the region of the four openings 54, just one fluorescence cube 56 being shown in FIGS. 2 and 3.

A motor 58 is further provided, by means of which the rotary table 52 can be rotated about its axis of rotation 60 so that one of the fluorescence cubes 56 in each case can be pivoted into the beam path of the microscope 10 as desired.

Each of the fluorescence cubes 56 comprises an excitation filter 60, a beam splitter 62 and a barrier filter 64. The light 66 emitted by the light source 38 first passes through the excitation filter 60, through which only the portion of the light 66 can pass that has the wavelengths required for exciting the fluorescence dye used. In contrast, the spectral range in which the fluorescence dye is luminous cannot pass through the excitation filter.

The light subsequently strikes the beam splitter 62. The beam splitter 62 reflects the light that has passed through the excitation filter 61 onto the specimen to be examined by microscope, whereupon the fluorescence is generated in this specimen. The specimen accordingly emits the fluorescence light which in turn reaches the beam splitter 62 and passes therethrough. In contrast, the excitation light reflected by the specimen is reflected back again by the beam splitter 62 towards the light source 38 and does not pass through the beam splitter 62.

The light subsequently passes through the barrier filter 64 which is designed such that only light having the wavelength of the fluorescence light can pass therethrough.

Since, depending on the fluorescence dye used, different fluorescence cubes are accordingly required in order to generate the required excitation light and, accordingly, to allow only the fluorescence light to pass through, a plurality of fluorescence cubes are provided on the rotary table 52, which cubes can be rotated into the beam path as desired. In the embodiment shown, a maximum of four fluorescence cubes 56 of this kind can be fastened to the rotary table 52. The fastening is achieved in particular by means of dovetail fixtures or snap-in connections. Alternatively, other types of fastening are also conceivable.

In an alternative embodiment of the invention, the rotary table 52 can also comprise eight places or a different number of places for fluorescence cubes 56.

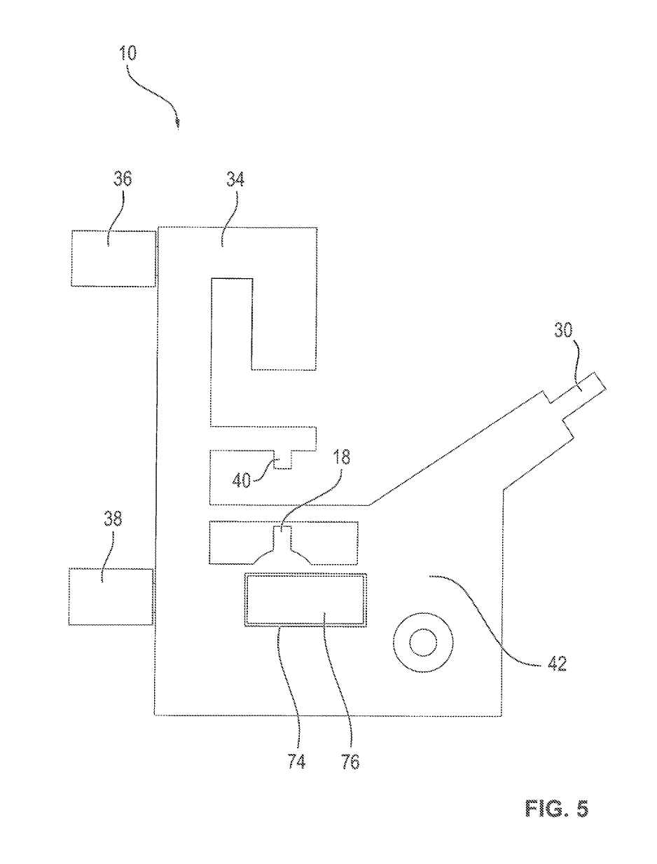

Since the number of fluorescence cubes 56 that can be received is thus limited by nature and is significantly smaller than the number of different possible fluorescence cubes 56, the fluorescence cubes 56 have to be changed frequently. In order to make it possible to exchange the fluorescence cubes 56 in a simple manner, and also to otherwise have good access to the fluorescence device 50, a first opening 70 is provided on the first side of the microscope 10, as shown in FIG. 4, which opening is closed, in FIG. 4, by a first cover 72. FIG. 5 is a schematic view of the microscope 10 viewed from the second side that is opposite the first side. A second opening 74 is also provided on this side, which opening can be closed by a second cover 76. By removing the covers 72, 76, it is thus possible to access the fluorescence device 50 from both sides, and therefore the fluorescence cubes 56 can be changed in particular from both sides.

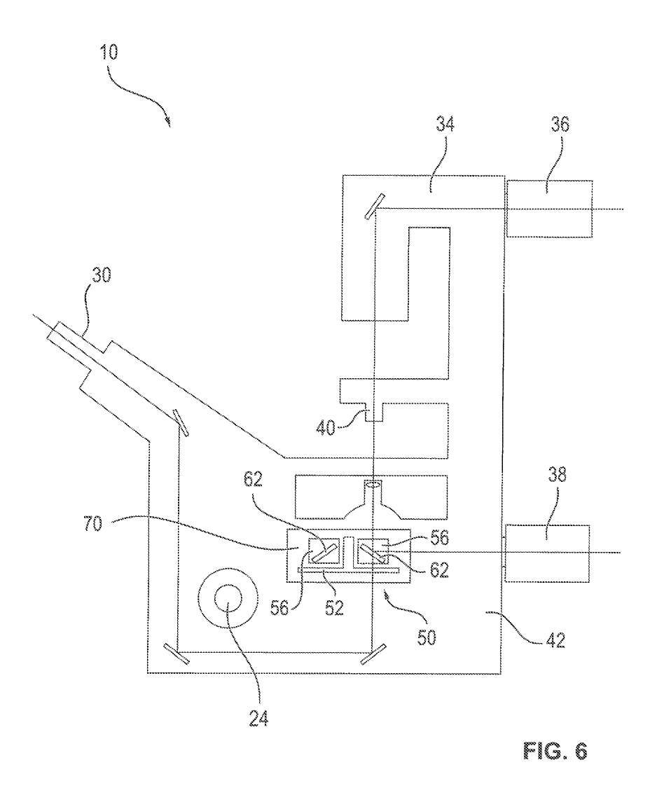

FIG. 6 is a schematic view of the microscope 10 according to FIGS. 4 and 5 viewed from the first side, the first cover 72 having been removed in this case so that the first opening 70 is open. In this case, the opening 70 is in particular designed to be of such a size that it is possible to easily access the fluorescence device 50 therethrough so that the fluorescence cubes 56 can in particular be exchanged without it being necessary to remove the rotary table 52 from the microscope 10 for this purpose.

In an alternative embodiment of the invention, a pivoting drawer or a drawer can also be provided, by means of which a rotary table 52 can be moved out of both the first opening 70 and the second opening 74, and therefore the fluorescence cubes 56 can be exchanged in a simple manner.

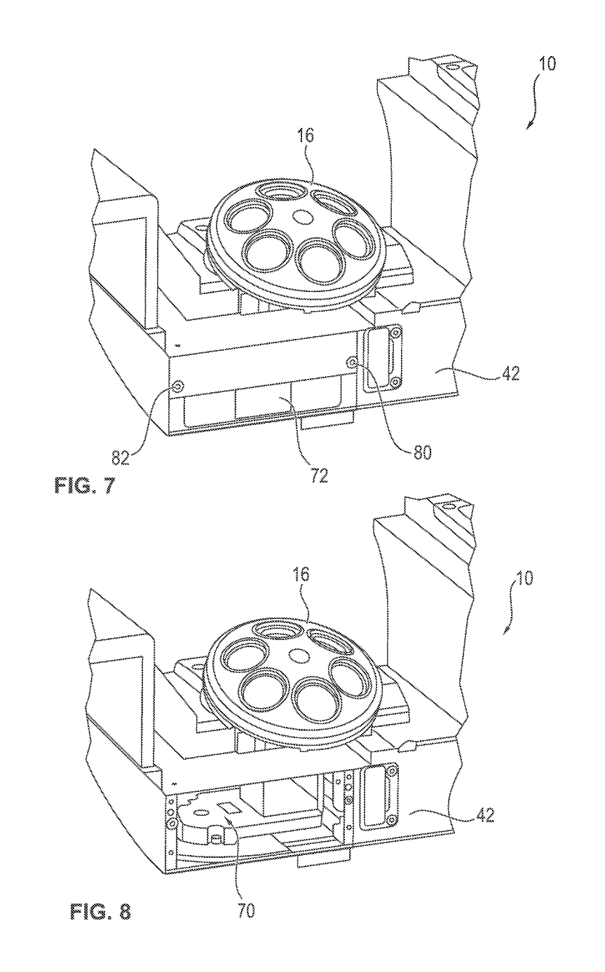

FIGS. 7 and 8 are each a schematic perspective view of a detail of the microscope according to FIG. 4 to 6, viewed from the first side, the first cover 72 being screwed to the housing 40 by means of two screws 80, 82 in FIG. 7, and the cover 72 having been removed in FIG. 8.

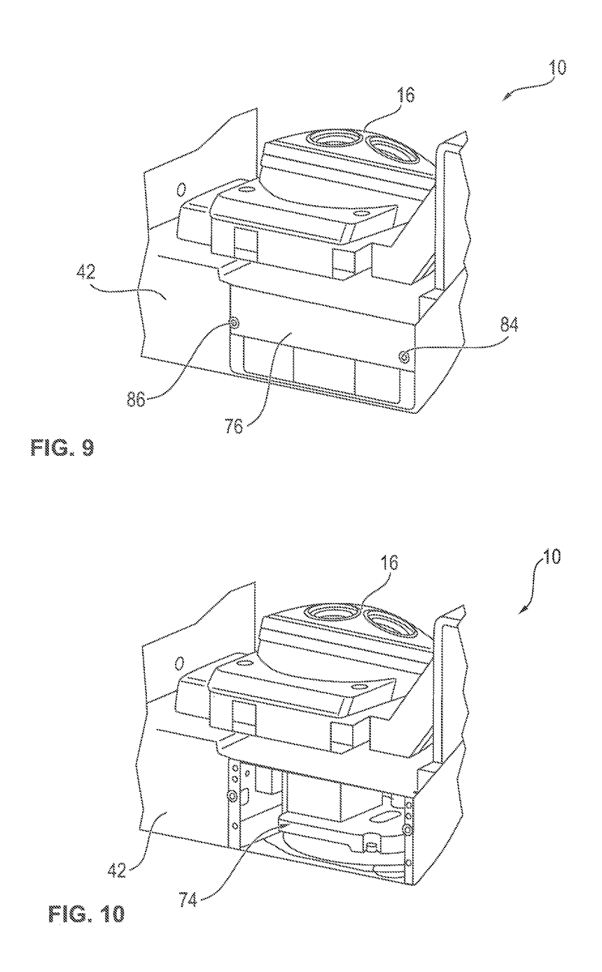

FIGS. 9 and 10 are each a schematic perspective detail of the microscope according to FIG. 4 to 6, viewed from the second side, the second opening 74 being closed by the second cover 76 in FIG. 9, which cover is in this case again screwed on by means of two screws 84, 86. In FIG. 10, in contrast, the second cover 76 has been removed, and therefore it is possible to access the fluorescence device 50.

In principle, magnets are sufficient for retaining the first cover 72 and the second cover 76. Therefore, in addition or as an alternative to the screws 80 and 82 for the first cover 72 and the screws 84 and 86 for the second cover 76, a plurality of magnets are attached to the housing 40 and to the first cover 72 and to the second cover 76 in each case, which magnets retain the first cover 72 and the second cover 76 in the relevant positions in the openings 74 by means of magnetic force. It is also conceivable to omit magnets from the first cover 72 and/or from the second cover 76 if said covers are manufactured from ferromagnetic material or magnetized material. However, the screw connection described above is always required for safety reasons when a laser beam is used in the microscope 10 and the first cover 72 and the second cover 76 are intended to protect a user of the microscope 10 from being harmed by the laser radiation.

The two covers 72, 76 are in particular designed identically, meaning that the two covers 72, 76 can be swapped as desired. Accordingly, in particular the first opening 70 and the second opening 74 are also the same size, meaning that the same convenient access is possible from both sides.

Providing two openings 70, 74 arranged on opposing sides means that it is possible to access the fluorescence device 50 from both sides, and therefore both left-handed and right-handed people can easily gain access and in particular can change the fluorescence cubes 56. Furthermore, the openings 70, 74 are particularly large, so that the exchange is possible without moving out the rotary table 52.

Furthermore, providing two openings 70, 74 on opposing sides means that an installation space for attaching additional or external components is defined in each case on a side of the microscope 10 that can be freely selected. In particular, mechanical and/or optical interfaces can be provided for this purpose, meaning that it is possible to couple a plurality of additional external units without the need for any restrictions in terms of the size of the units. In particular, additional components such as cameras, micromanipulators, light sources, sample feeders, climate chambers, filter slides or camera ports can be provided. Providing the openings 70, 74 means that access to the fluorescence device 50 is also always possible without the entire additional units first having to be removed again, irrespective of the side on which the units are arranged.

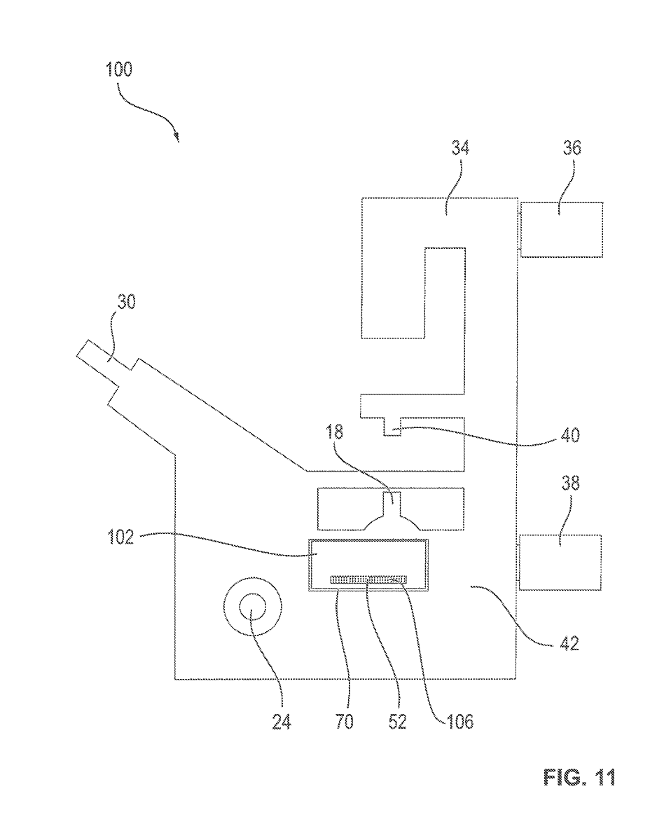

FIG. 11 to 16 show a microscope 100 according to a second embodiment, this microscope 100 differing from the microscope 10 of the first embodiment in that the rotary table 52 is not rotated by a motor 58 but rather can be rotated manually. Elements having the same design or the same function have been provided with the same reference signs.

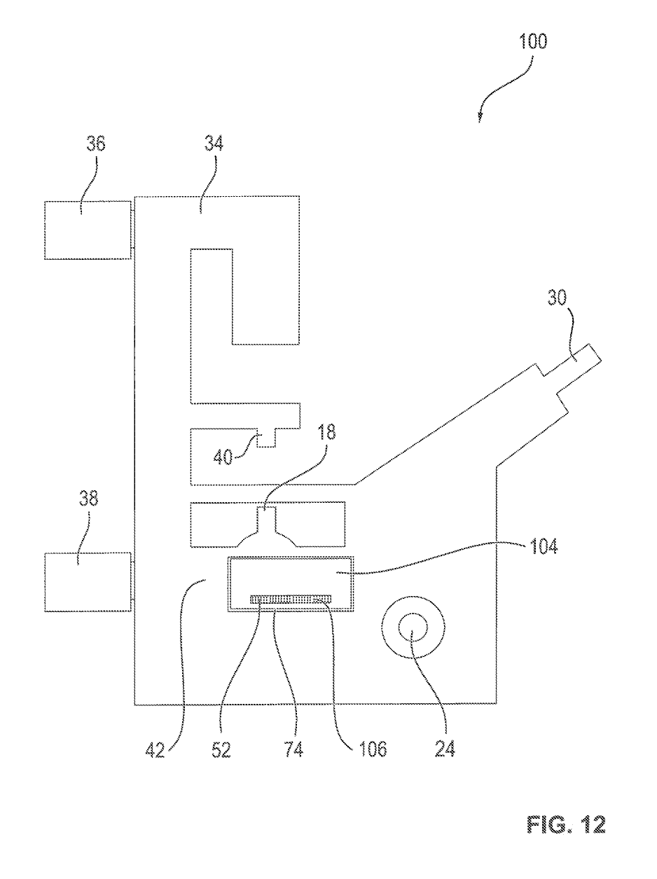

A schematic view of the microscope 100 according to the second embodiment is shown viewed from the first side in FIG. 11 and viewed from the second side in FIG. 12.

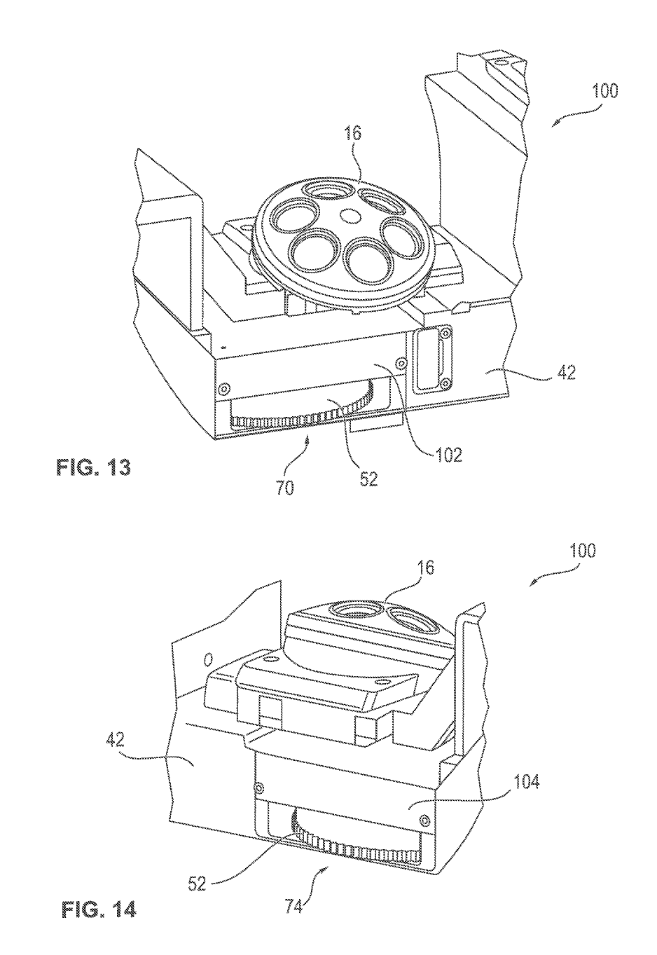

A schematic perspective view of a detail of the microscope 100 is shown viewed from the first side in FIG. 13 and viewed from the second side in FIG. 14.

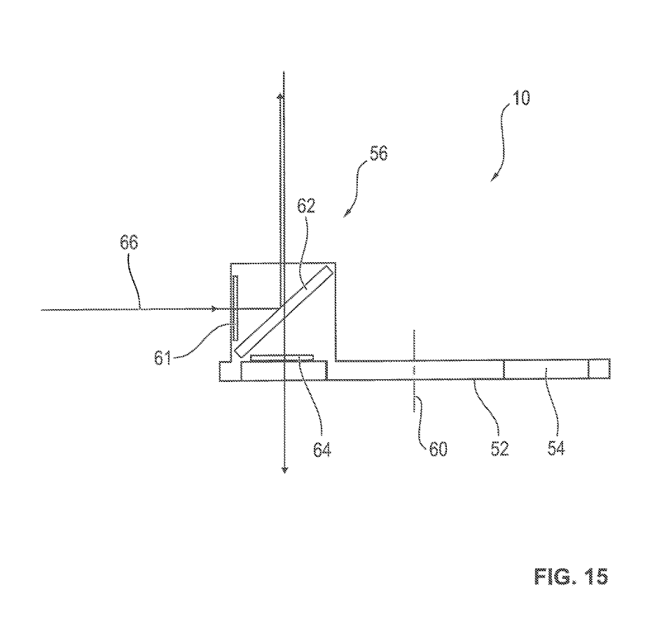

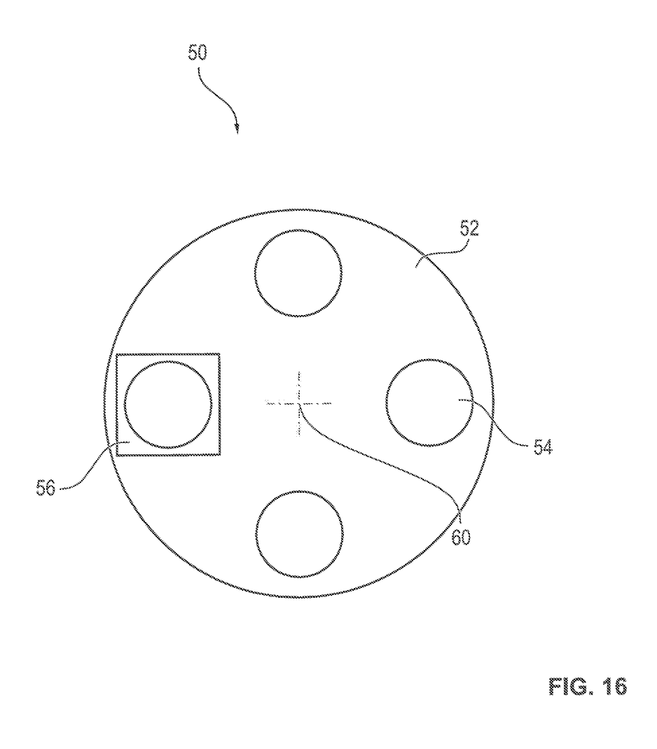

FIG. 15 is a side view and FIG. 16 is a plan view of the fluorescence device 50 of the microscope 100. This fluorescence device 50 does not have a motor, but instead the rotary table 52 is rotated manually by the operator of the microscope 100. For this purpose, both the first cover 102 for closing the first opening 70 and the second cover 104 for closing the second opening 74 are designed so as to not completely close the respective openings 70, 74, but instead it is possible to access the rotary table 52 so that the operator can rotate said table. For this purpose, the rotary table 52 in particular protrudes slightly from both the first opening 70 and the second opening 74, and therefore said table can be more easily rotated by the operator. Furthermore, in order to facilitate the rotation, grooves 106 are provided on the edge of the rotary table 52. The covers 102, 104 are in particular again screwed to the housing 40, the screw pattern being designed in a manner similar to that of the covers 72, 76 in the first embodiment, such that the completely closing covers 72, 76 and the covers 102, 104 that close only in part can be interchanged in any desired manner. This in particular makes it possible, also in the embodiment according to FIG. 11 to 16, for one side to be closed by a completely closing cover 72, 76 and for access to the rotary table 52 to be permitted only on the other side by a corresponding cover 102, 104 that does not close completely. By swapping these two covers 72, 76, 102, 104, the operator is free to select the side from which he wishes to rotate the rotary table 52.

In a further alternative embodiment of the invention, the covers 72, 76, 102, 104 can, however, also be fastened to the housing 40 by elements other than screws 80 to 86.

Furthermore, it is also possible for the covers 72, 76, 102, 104 to not be completely removable but instead to be fastened to the housing 40 such that they can be folded away downwards, for example, and therefore cannot be lost.

The embodiments in FIG. 1 to 16 relate to an inverted microscope. Of course, the principle of the two openings can also be applied to upright microscopes in which the fluorescence device 50 is arranged in the upper part of the microscope.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10, 100 microscope
12 tripod main body
14 microscope stage
16 rotating nosepiece
18 objective
20 nosepiece support
22 recess
24 rotary knob
26 grooves
30 ocular lens
32 tube
34 transillumination arm
36 transmitted light source
38 incident illumination unit
40 condenser
42 housing
50 fluorescence device
52 rotary table
54 opening
56 fluorescence cube
58 motor
60 axis of rotation
61 excitation filter
62 beam splitter
64 barrier filter
66 light
70 first opening
74 second opening
72 first cover
76 second cover
102, 104 cover
80, 82, 84, 86 screws
106 grooves
P1 direction

1: A microscope, comprising:
a housing having a first opening and at least one second opening; and
a fluorescence device having exchangeable fluorescence cubes, the fluorescence device being arranged in a space enclosed by the housing, the fluorescence device being accessible through each of the first opening and the at least one second opening such that a total of at least two openings are provided, via each of which the fluorescence device is accessible and via each of which the fluorescence cubes of the fluorescence device are exchangeable.

2: The microscope according to claim 1, wherein the first opening and the at least one second opening are arranged on opposing sides of the housing.

3: The microscope according to claim 1, wherein the first opening and the at least one second opening are designed identically.

4: The microscope according to claim 1, wherein a first cover is provided for closing the first opening at least in part and/or a second cover is provided for closing the at least one second opening at least in part.

5: The microscope according to claim 4, wherein the first cover completely closes the first opening and/or the second cover completely closes the at least one second opening.

6: The microscope according to claim 4, wherein the first cover closes the first opening only in part and/or the second cover closes the second opening only in part.

7: The microscope according to claim 4, wherein the first cover and the second cover are configured to be fastened to each of the at least two openings as desired.

8: The microscope according to claim 4, wherein the first cover and the second cover are designed identically.

9: The microscope according to claim 4, wherein the first cover and/or the second cover is screwable to the housing.

10: The microscope according to claim 1, wherein the fluorescence device comprises a rotary table that is rotatable about an axis of rotation and is configured to receive a plurality of exchangeable fluorescence cubes therein.

11: The microscope according to claim 10, wherein the first opening and the at least one second opening are designed such that the rotary table is removable through both the first opening and the at least one second opening.

12: The microscope according to claim 10, wherein the rotary table is dimensioned and positioned such that the fluorescence cubes are exchangeable through both the first opening and the at least one second opening without it being necessary to remove the rotary table.

13: The microscope according to claim 10, wherein the rotary table is arranged on a drawer configured to be moved or pulled out of both the first opening and the at least one second opening.

14: The microscope according to claim 10, wherein the rotary table is arranged on a pivotable drawer configured to be pivoted out of both the first opening and the at least one second opening.

15: The microscope according to claim 10, further comprising a motor configured to rotate the rotary table.

16: The microscope according to claim 10, wherein the rotary table protrudes from the first opening and/or from the at least one second opening so as to allow manual rotation of the rotary table.

17: The microscope according to claim 16, wherein an edge of the rotary table comprises grooves.

18: The microscope according to claim 10, wherein the rotary table comprises at least four receiving regions, each of the receiving regions being configured to respectively receive one fluorescence cube.
